(19) United States
(12) Patent Application Publication
(10) Pub. No.: US 2024/0249253 A1
(43) Pub. Date: Jul. 25, 2024

(54) Event Mesh-Based Multi-Gateway Payment Processing System

(71) Applicant: Bank OF America Corporation, Charlotte, NC (US)

(72) Inventors: Lee Barry Frantz, Souderton, PA (US); Lee Ann Proud, St. Augustine, FL (US); Hosam Sonny EIHamahmy, Fort Mill, SC (US)

(73) Assignee: Bank OF America Corporation, Charlotte, NC (US)

(21) Appl. No.: 18/158,269

(22) Filed: Jan. 23, 2023

(51) Int. Cl. G06Q 20/02; G06Q 20/30

(52) U.S. Cl. CPC G06Q 20/027; G06Q 20/30

(57) ABSTRACT

Various aspects of the disclosure relate to management of messaging from multiple payment gateway devices via a gateway management device via a publication/subscription based event mesh network. A payment transaction is initiated via a terminal associated with a processor, where the terminal broadcasts an electronic transaction topic to an event mesh network. The gateway management device subscribes to messages published to the event mesh network by each of the multiple payment gateway devices. The gateway management device manages distribution of the payment transaction requests via published messages to the event mesh network, by formatting a message header targeting devices associated with the published electronic transaction topic. Various services and/or applications subscribe to messages broadcast by the gateway management device over the event mesh network and perform actions including fraud investigation activities and/or completing the payment transaction based on instructions included in the message header of the published electronic transaction topic.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization, such as payment processing, consumer debit accounts, consumer credit accounts, merchant deposit processing, and/or the like. Organizations and users may communicate with one another in different ways using payment processing methods and platforms that are both centralized and decentralized.

As a result of the complexity associated with the payment operations of a large organization and its computer systems, it may be difficult for such an organization, such as a financial institution, to efficiently, effectively, securely, and uniformly manage its computer systems, and particularly manage how internal computer systems exchange information with external computer systems in providing and/or supporting different products and services offered by the organization. For example, current payment processing systems may encounter issues with multiple payment gateways connecting to the payment systems infrastructure of a financial institution (e.g., a bank), thus requiring complex configuration logic to ensure proper and efficient processing of transactions.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Aspects of the disclosure relate to computer hardware and software. In particular, one or more aspects of the disclosure generally relate to computer hardware and software for transaction processing and, more specifically, to an event-based mesh network communication for payment processing.

A transaction sometimes involves transfer of value, in the form of money, between two entities. The transaction may be processed based on transmission of a message from one entity to another. For example, a computing platform associated with a merchant's financial transaction processing equipment may transmit, to a computing platform associated with financial institution's payment processing system, a message indicating a request to process a payment (e.g., a credit transaction, a debit transaction, and/or the like) via the transfer channel. Different credit cards, merchant transaction processing applications, gateway processors and/or the like may introduce network inefficiencies due to a large number of factors that may need to be accounted for when configuring the network. Additionally, governmental regulations may introduce other requirements that may require customized programming and/or additional processing for each transaction to ensure processing follows local and/or regional regulations.

Utilizing existing event driven architecture and event mesh technology to allow for multiple gateways to connect to a single gateway processor. This allows for a single gateway processor to identify and classify more than one inbound gateway to facilitate a single stream of information for downstream processing applications. Introduction of a gateway event mesh to support multiple gateway processors in both on premise and private cloud configurations. This innovation will enable multiple gateways to publish/connect to a single gateway processor.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for a payment gateway management system, in accordance with one or more aspects described herein;

FIG. 1B shows an illustrative computing platform enabled for a payment gateway management system, in accordance with one or more aspects described herein;

FIG. 2A shows an illustration of present methods to interface with payment gateways within an enterprise computing system;

FIG. 2B show an illustrative process for configuring a payment gateway management system according to one or more aspects described herein; and

FIG. 3 shows an illustrative a regionalized payment gateway management system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

A financial institution may provide different products and services to their customers, such as by providing banking services to merchants and consumers. To facilitate financial transactions between merchants and consumers, the financial institution may provide payment processing systems that facilitate electronic processing of financial transactions such as by connecting a credit card, or debit card, services associated with the customer to facilitate a payment transaction to a merchant, such as by depositing funds into a deposit account associated with the merchant. Such payment transactions may be facilitated through use of a payment gateway. A payment gateway is a technology, that may be used by merchants to accept debit or credit card purchases from consumers and may include physical card readers, online payment processing portals, and/or the like. With current advances in technology, more payment methods have been developed (e.g., near field communication (NFC) technology, QR codes, cryptocurrency transaction technologies, and the like) have introduced additional complexity into the financial institution's payment processing systems, because in current systems, each payment gateway technology must be handled independently and thus introduces delays and increases processing overhead in both transaction processing and routing. Additionally, the financial institution may be required to add additional computing devices to handle the workload.

As mentioned, payment gateways may be considered an input point into a bank's (or other financial institution's) payment processing system to interface with card networks to complete processing of a consumer transaction. To meet changing market demands, the financial institution may be required to modify their network interfaces to support each new payment gateway as they are introduced. For example, in an illustrative system, three different payment gateways may be supported, where each gateway may utilize a different communication method or protocol to communicate to a switching platform. With the payment gateway management system, support for different gateways may be standardized with a common connection process to minimize customized configuration of the enterprise network (e.g., multiple connection ports, Transmission Control Protocol (TCP) connections, and the like) and thus simplify the network architecture.

To avoid the issues and to allow for simplified and traceable payment processing, the financial institution may introduce a centralized payment gateway management system where, instead of reconfiguring the computing system to allow each payment gateway a dedicated communication channel to the payment switch and merchant deposit account platform, the payment gateway management system may include an acquirer processor through which all gateways interface and then distribute communications to the desired backend system or systems. As such, the payment gateway management system may provide a “gateway for payment gateways” into the payment processing computing system. The payment processing computing system may utilize a mesh network to leverage an event driven communication system, such as a publication/subscription (pub/sub) messaging system. The payment processing computing system may also facilitate additional processing to the incoming transaction request received from the processing gateways, such as fraud prevention functionalities and the like. For example, the payment gateway management system may temporarily hold a transaction to divert the transaction to a fraud prevention computing system before completing a transaction.

In some cases, the payment gateway management system may utilize an event mesh as the “backbone” of the system communications. An event mesh is a configurable and dynamic infrastructure layer for distributing events among decoupled applications, cloud services and/or computing devices on a decentralized computing network. With the event mesh, the payment gateway management system may communicate payment transaction data across distributed infrastructure that is not just geographically and/or technologically dispersed in an efficient, scalable, and economical manner. Further, the event mesh allows for simpler distribution of transactions across geographic regions to allow for customization of processing to meet local and/or regional regulatory requirements. In the event driven system, an action (e.g., a payment transaction request) received via a payment gateway may produce a notification, which is then received by the payment gateway management system to react to the event. Additionally, the event mesh allows the payment gateway management system to process large numbers of payment events (e.g., tens of thousands of events) that may be generated every minute. The payment gateway management system provides an effective way to deliver a high volume of payment transaction requests to particular merchant account platforms deployed across a distributed combination of cloud and on-premise environments. With the event mesh, the payment gateway management system may provide a platform agnostic messaging system that allows publishing and/or subscribing systems to use the events regardless of development platform technology, messaging technology and/or host computing platform (e.g., a cloud-based host platform, an on-premises host platform, and/or the like.

In some cases, the payment gateway management system may allow for customization of transaction processing based on unique aspects of a particular payment transaction. For example, the payment gateway management system may be programmed to perform additional analysis of the transaction information to identify a source of a payment type (e.g., a credit card source, a debit card source, a cryptocurrency source, and the like) and a deposit account location. For example, if the payment gateway management system may identify that the financial institution is a source of both the payment method of the consumer and the deposit account of the consumer, the payment transaction may be routed to a different local computing system to finalize payment within the enterprise organization network and bypass certain processing channels to facilitate faster processing of the transaction request by minimizing processing overhead. Additionally, the payment gateway management system may identify a geographic location of a transaction, the consumer payment method (e.g., credit card, debit card, cryptocurrency wallet, and the like), a geographic location of where the transaction was initiated, a location of the merchant, a geographic location of the merchant deposit account and/or the like, geographic region associated with one or more aspects of the transaction. With this information, payment gateway management system may route the transaction request to a particular processing center associated with that region for processing. For example, some countries may require transaction processing to be performed in an on-premises site rather than in a cloud computing environment. Further, more accurate records may be stored based on stored transaction information, identification of payment gateway publishers subscribed to by the payment gateway management system and/or identification of subscribers to information published by the payment gateway management system.

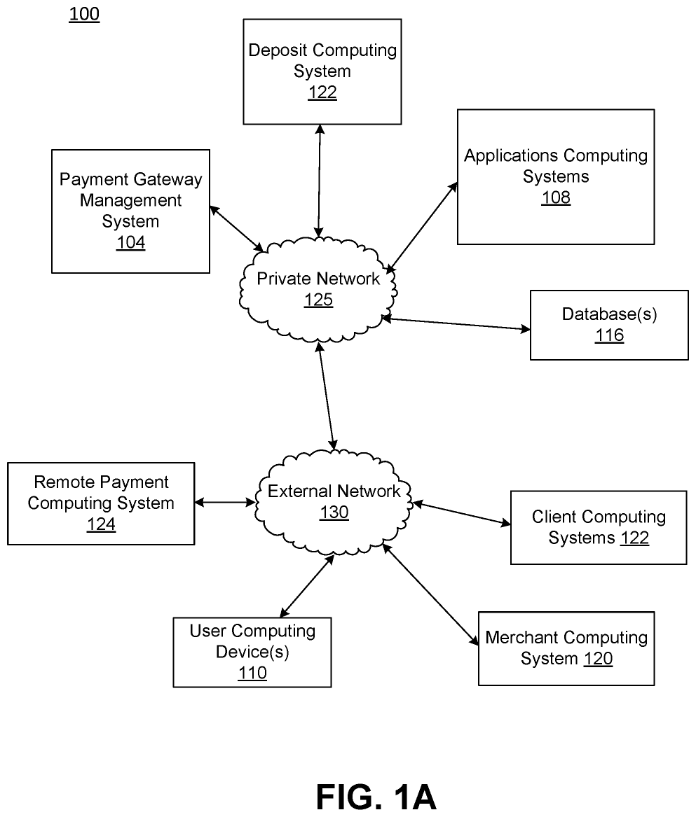

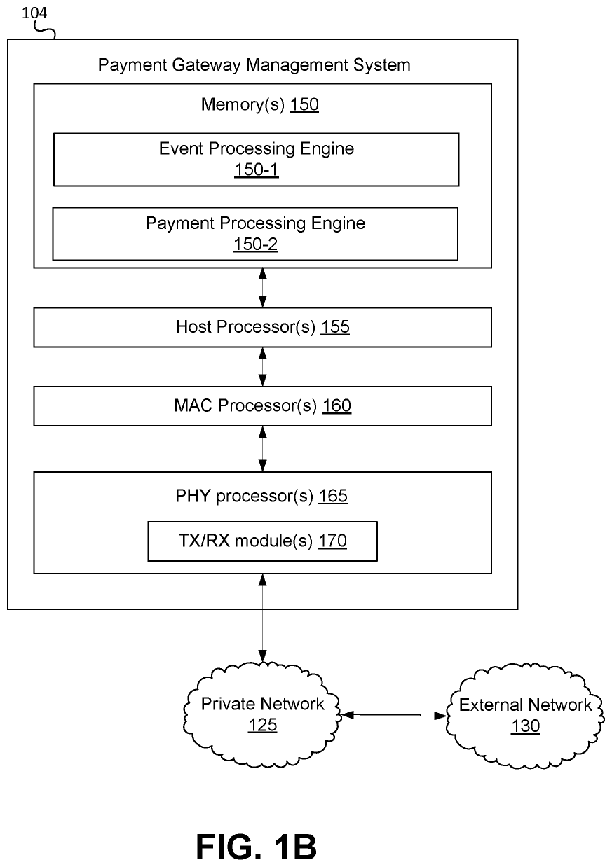

FIG. 1A shows an illustrative computing environment for a payment gateway management system, in accordance with one or more aspects described herein. The computing environment 100 may comprise one or more devices (e.g., computer systems, communication devices, and the like). The computing environment 100 may comprise, for example, a payment gateway management system 104, one or more application computing systems 108, a deposit computing system 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120, a remote payment computing system 124, a merchant computing system 122, and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the payment gateway management system 104 as being a separate computing system, the payment gateway management system 104 may be implemented within another computing system, such as one or more application computing systems 108 and/or the deposit computing system 122.

The payment gateway management system 104 may comprise one or more computing devices and/or other computer components (e.g., processors, memories, communication interfaces) configured to perform one or more functions as described herein. Further details associated with the architecture of the payment gateway management system 104 are described with reference to FIG. 1B.

The application computing system 108, the merchant computing system 120, the remote payment computing system 124, and/or the client computing systems 122 may comprise one or more computing devices and/or other computer components (e.g., processors, memories, communication interfaces). In addition, application computing system 108, the merchant computing system 120, the remote payment computing system 124, and/or the client computing systems 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing systems 122 may be configured to communicate with one or more of the application systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The deposit computing system 122 may be configured to deposit funds into an electronic account associated with a merchant in response to a processed payment transaction. The remote payment computing system 124 and/or the merchant computing system 120 may include one or more payment gateways through which payment transactions may be initiated and communicated to the payment gateway management system 104 initiate completion of an associated payment transaction request. The application computing system 108, the merchant computing system 120, the remote payment computing system 124, and/or the client computing systems 122 may comprise various servers and/or databases that store and/or otherwise maintain account information, such as financial account information including account balances, transaction history, account owner information, and/or other information. In addition, the application computing system 108, the merchant computing system 120, the remote payment computing system 124, and/or the client computing systems 122 may process and/or otherwise execute transactions on specific accounts based on commands and/or other information received from other computer systems comprising the computing environment 100. In some cases, one or more of the application computing system 108, the merchant computing system 120, the remote payment computing system 124, and/or the client computing systems 122 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application system 108 may be linked to and/or operated by a specific enterprise user (who may, for example, be an employee or other affiliate of the enterprise organization) who may have administrative privileges to perform various operations within the private network 125. In some cases, the application computing system 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The merchant computing system 120, the remote payment computing system 124, and/or the client computing systems 122 may comprise one or more computing devices and/or other computer components (e.g., processors, memories, communication interfaces). The merchant computing system 120, the remote payment computing system 124, and/or the client computing systems 122 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the merchant computing system 120, the remote payment computing system 124, and/or the client computing systems 122 is for processing an electronic exchange of goods and/or services. The merchant computing system 120, the remote payment computing system 124, and/or the client computing systems 122 may be associated with a specific goods purchasing activity, such as purchasing a vehicle, transferring title of real estate may perform communicate with one or more other platforms within the merchant computing system 120, the remote payment computing system 124, and/or the client computing systems 122. In some cases, the client computing system 120 may integrate API calls to request data, initiate functionality, or otherwise communicate with the one or more application computing systems 108, such as via the services. For example, the services may be configured to facilitate data communications (e.g., data gathering functions, data writing functions, and the like) between the merchant computing system 120, the remote payment computing system 124, and/or the client computing systems 122.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the payment gateway management system 104. For example, the database(s) 116 may store information corresponding to publisher information and/or subscriber information, thresholds and/or other information that may trigger additional processing of electronic payment transactions before completing the payment transaction, and the like. In an arrangement, the database(s) 116 may be used for other purposes as described herein. In some cases, the client computing system 120 may write data or read data to the database(s) 116 via the services.

In one or more arrangements, the payment gateway management system 104, one or more application computing systems 108, a deposit computing system 122, and/or one or more database(s) 116, the merchant computing system 120, the remote payment computing system 124, the client computing systems 122, the user devices 110, and/or the other devices/systems in the computing environment 100 may be any type of computing device capable of receiving input via a user interface, and communicating the received input to one or more other computing devices in the computing environment 100. For example, the payment gateway management system 104, one or more application computing systems 108, a deposit computing system 122, and/or one or more database(s) 116, the merchant computing system 120, the remote payment computing system 124, the client computing systems 122, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the payment gateway management system 104, one or more application computing systems 108, a deposit computing system 122, and/or one or more database(s) 116, the merchant computing system 120, the remote payment computing system 124, the client computing systems 122, the user devices 110, and/or the other devices/systems in the computing environment 100 may, in some instances, be and/or comprise special-purpose computing devices configured to perform specific functions.

FIG. 1B shows an illustrative payment gateway management system 104 in accordance with one or more examples described herein. The payment gateway management system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The payment gateway management system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the payment gateway management system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 155. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the payment gateway management system 104 may be configured to execute machine readable instructions stored in memory 150. The memory 150 may comprise (i) one or more program modules/engines having instructions that when executed by the one or more processors cause the payment gateway management system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the payment gateway management system 104 and/or by different computing devices that may form and/or otherwise make up the payment gateway management system 104. For example, the memory 150 may have, store, and/or comprise an event processing engine 150-1, a payment processing engine 150-2, and/or the like. The event processing engine 150-1 may have instructions that direct and/or cause the payment gateway management system 104 to perform one or more operations associated with identifying incoming payment transaction requests, analyzing information associated with the transactions to identify additional actions to be performed corresponding to the identified information, initiating the additional actions if necessary, communicating the payment request for processing, and the like. The payment processing engine 150-2 may have instructions that may cause the payment processing engine 105 to publish the payment transaction request information to initiate processing and/or completion of the payment transaction.

While FIG. 1A illustrates components of system 100 as being separate elements connected in the private network 125, in one or more other arrangements, functions of one or more of the above may be integrated in a single device/network of devices. For example, elements in the payment gateway management system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application systems 108.

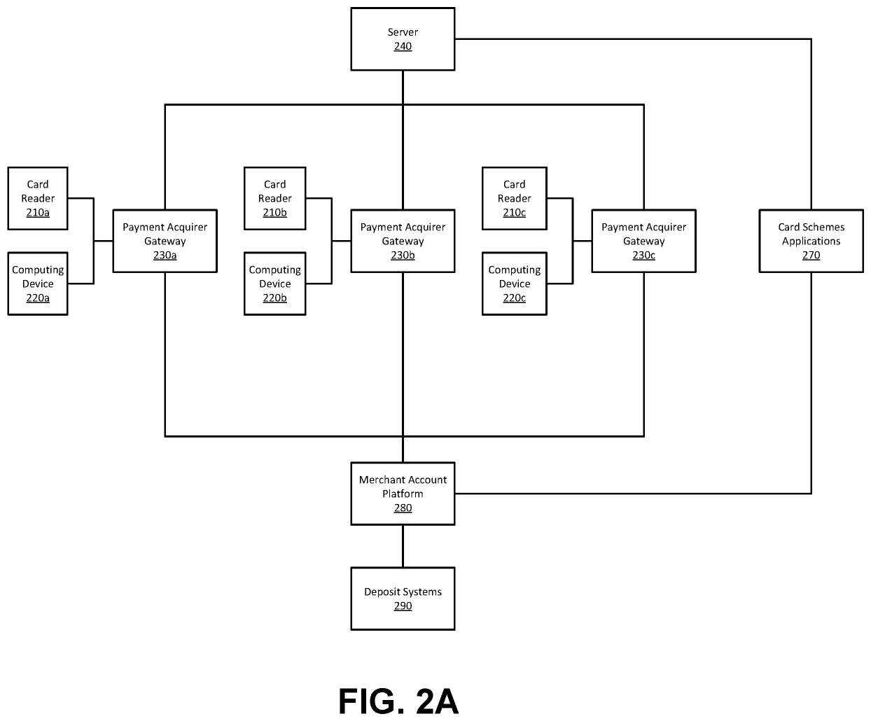

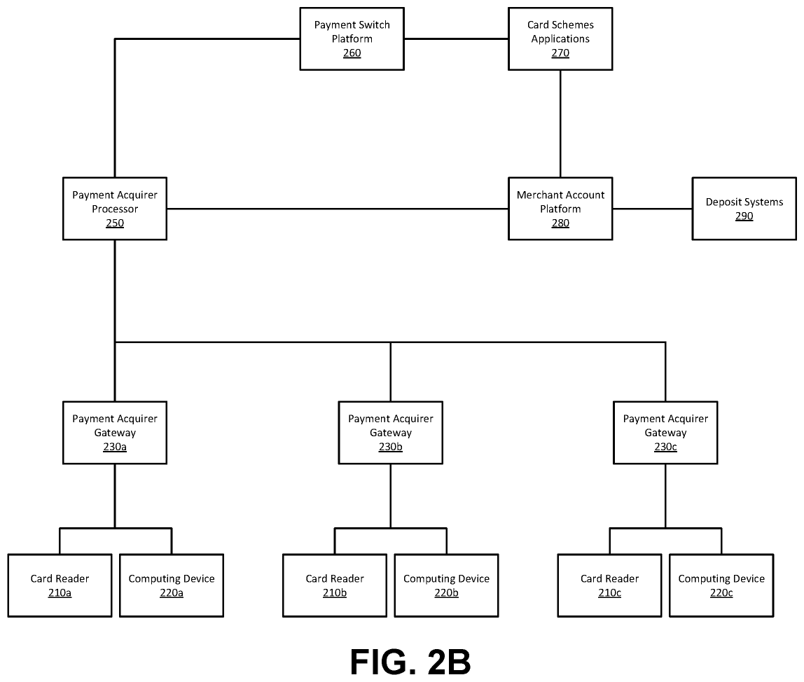

FIG. 2A shows an illustration of present methods to interface with payment gateways within an enterprise computing system. As discussed briefly above, current payment processing systems may require each payment gateway (e.g., a payment acquirer gateway 230a, 230b, and 230c) to be independently and directly connected to a payment server 240 and a merchant account platform 280. For example, the payment server 240 may facilitate routing to particular credit card and/or debit card processing applications unique to a particular card network before routing the information to the merchant account platform 280. In some cases, the credit card processing information and the payment transaction information may be separately communicated to the merchant account platform 280 from the card scheme applications 270 and the payment acquirer gateway 230b. Once processed, the payment transaction may be completed via the merchant account platform 280 instructing deposit of associated funds within a merchant account within the deposit systems 290.

FIG. 2B show an improved process for configuring a payment gateway management system according to one or more aspects described herein. The improved system may include a payment entry system at each of a plurality of merchants (e.g., a card reader 210a, 210b, and 210c, a computing device interface 220a, 220b, and 220c). In some cases, the card reader 210a may facilitate payments from a consumer account via a credit card or a debit card. The computing interface 220a may facilitate a payment transaction via an online portal or other such computerized payment method. In some cases, different payment methods may require a different payment acquirer gateway 230a, 230b, or 230c. For example, a credit card transaction via card reader 210a may be facilitated through a payment acquirer gateway 230a, an electronic wallet based payment transaction may be facilitated via the payment acquirer gateway 230b, and a cryptocurrency payment transaction may be facilitated via the payment acquirer gat gateway 230c. Each payment acquirer gateway 230a, 230b, and 230c may communicate payment transaction request information to the payment acquirer processor 250, such as by publishing the information via a service to which the payment acquirer processor 250 subscribes.

The payment acquirer processor may analyze the information to identify whether additional processing may be required and communicate a request to subscribed applications. For example, if the payment transaction request meets qualifications to initiate an investigation (e.g., a fraud investigation), the payment acquirer processor 250 may publish the payment request information to subscriber applications associated with security review. The payment acquirer processor 250 may further publish the payment request to subscriber applications to complete the transaction, such as the payment switch platform and/or the merchant account platform. In doing so, the payment acquirer processor 250 is configured as a single input for all payment acquirer gateways 230a, 230b, and 230c by subscribing to messages published by all payment acquirer gateways 230a, 230b, and 230c. Additionally, the payment acquirer processor 250 is configured as a single source for all subscribing payment request processing applications, such as the payment switch platform 260 and the merchant account platform 280. As discussed above, the payment switch platform 260 may identify and/or route a payment transaction request to an associated payment network (e.g., credit card network), which in turn, provides information to the merchant account platform 280 to complete the payment through deposit of funds in the associated merchant account via the deposit systems. In some cases, if the payment acquirer processor 250 identifies that all accounts (e.g., consumer credit card accounts, consumer debit card accounts, merchant deposit account, and the like) are all associated with a same financial institution, the payment acquirer processor 250 may publish a message that is subscribed to only by applications associated with the same financial institution to streamline processing of the payment transaction to reduce processing times and messaging outside the financial institution's computing network.

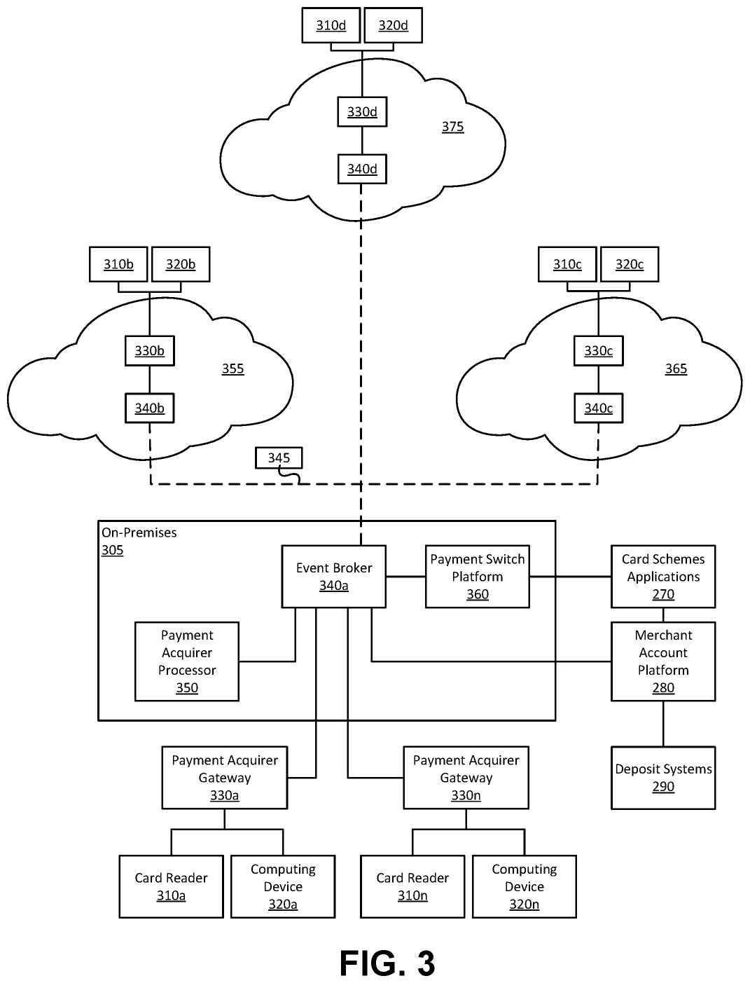

FIG. 3 shows an illustrative a regionalized payment gateway management system with an event mesh in accordance with one or more aspects described herein. The regionalized payment gateway management system of FIG. 3 may include one or more on-premises processing center 305 and/or one or more cloud-based payment processing centers 355, 365, and 375. Each processing center may be associated with one or more payment gateways, such as the payment acquirer gateway 330a and 330n associated with the on-premises processing center 305, the payment acquirer gateway 330b associated with the cloud-based payment processing center 355, the payment acquirer gateway 330c associated with the cloud-based payment processing center 365, and the payment acquirer gateway 330d associated with the cloud-based payment processing center 375. Each payment acquirer gateway 330a, 330n, 330b, 330c, and 330d may be associated with one or more of a card reader 310a, 310b, 310c, 310d, and/or 310n or a computing interface 320a, 320b, 320c, 320d, and/or 320n. The payment acquirer processor 350 may interface with an event broker 340a to facilitate communication via an event mesh 345 between the on-premises sites and the cloud based sites.

Each patent acquirer gateway 330a, 330n, 330b, 330c, and 330d may publish payment transaction request information via the event mesh 345a that may be subscribed to by the payment acquirer processor 350. In some cases, the payment acquirer processor 350 may be centrally located. In some cases, each site may have a payment acquirer processor that handles local transaction requests and only publishes between regions when analysis of a particular transaction identifies conditions requiring communication to a different region for processing. For example, one or more sites (e.g., the on-premises site 305, and the different cloud sites 345, 355, and 365 may be associated with a different regional location. For example, the on-premises site may be associated with a first geographic location (e.g., a regional area within a first country) and each cloud site may be associated with a different geographic region, where each region is associated with a different event broker 340a, 340b, 340c, and 340d.

The payment acquirer processor 350 (e.g., a payment gateway manager) may communicate payment transaction information via events, such as by publishing and/or subscribing to topics. Topics may be configured as a wrapper comprising a topic address and a payload including the payment transaction information (e.g., <Topic Address><Payload:: Payment Transaction Request>. The topic address may include information corresponding to source payment gateway and other information. For example a topic address may have a format such that values within the format may correspond to certain values as shown in the illustrative example below:

```
Topic Address: {Gateway}/Gateway Processor}/{ISO Version}/{Message
Class}/Message Function}/{Message Origin}
Gateway: The gateway source.
  displayName: “Gateway #1” :: value: “0”
  displayName: “Gateway #2” :: value: “1”
  displayName:“Gateway #3” :: value: “2”
Gateway Processor: The gateway processor source
  displayName: “Gateway Processor #1” :: value: “0”
  displayName:“Gateway Processor #2” :: value: “1”
  displayName:“Gateway Processor #3” :: value: “2”
ISO version: The first digit of the MTI indicates the ISO 8583 version in
which the message is encoded.
  displayName: “ISO 8583:1987” :: value: “0”
  displayName:“ISO 8583:1993” :: value: “1”
  displayName:“ISO 8583:2003” :: value: “2”
  displayName:“ISO 20022:xxxx” :: value: “3”
ISO message class: Position two of the MTI specifies the overall purpose
of the message.
  displayName: “” :: value: “0”
  displayName:“Authorization” :: value: “1”
  displayName:“Financial” :: value: “2”
  displayName:“File actions” :: value: “3”
  displayName:“Reversal and chargeback” :: value: “4”
  displayName:“Reconciliation” :: value: “5”
  displayName:“Administrative” :: value: “6”
  displayName:“Collection” :: value: “7”
  displayName:“Network management” :: value: “8”
ISO message function: Position three of the MTI specifies the message
function which defines howthe message should flow within the system.
Requests are end-to-end messages, while advices are point-to-point
messages.
  displayName: “Request” :: value: “0”
  displayName:“Request response” :: value: “1”
  displayName:“Advice” :: value: “2”
  displayName:“Advice response” :: value: “3”
  displayName:“Notification” :: value: “4”
  displayName:“Notification acknowledgement” :: value: “5”
  displayName:“Instruction” :: value: “6”
  displayName:“Instruction acknowledgement” :: value: “7”
  displayName:“” :: value: “8”
ISO message origin: Position four of the MTI defines the location of the
message source within the payment chain.
  displayName: “Acquirer” :: value: “0”
  displayName:“Acquirer repeat” :: value: “1”
  displayName:“Issuer” :: value: “2”
  displayName:“Issuer repeat” :: value: “3”
  displayName:“Other” :: value: “4”
  displayName:“Other repeat” :: value: “5”
  displayName:“Reserved” :: value: “6”
```

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method comprising:
receiving, by a gateway management device and from a payment gateway device, an indication of an electronic transaction request via a messaging service;
generating, by the gateway management device and based on the indication of the electronic transaction request, a message comprising a header and body comprising the indication of the electronic transaction request;
broadcasting, by the gateway management device via a publication/subscriber service, the message to a payment switch platform and an account processing system; and
triggering, based on the broadcasted message, completion of the transaction by the account processing system.

2. The method of claim 1, wherein the publication/subscriber service comprises and event mesh network.

3. The method of claim 1 further comprising:
subscribing, by the gateway management device, to messages posted by each payment gateway device of a plurality of gateway devices to an event mesh network; and
publishing, by each payment gateway device, a payment request message to initiate a payment transaction in response to a consumer request.

4. The method of claim 1 further comprising:
subscribing, by the payment switch platform and the account processing system, to messages posted by the gateway management device to an event mesh network; and
wherein the broadcasting of the message comprises publishing a topic to the event mesh network.

5. The method of claim 1 comprising:
analyzing, by the gateway management device, the indication of the electronic transaction request, wherein the broadcasting of the message comprises publishing a topic to an event mesh network; and
generating the topic based on characteristics of electronic transaction request.

6. The method of claim 5 wherein the topic is published to a targeted account processing system based on a geographic location associated with the electronic transaction request.

7. The method of claim 6 wherein the targeted account processing system is instantiated in a cloud-based environment.

8. The method of claim 6 wherein the targeted account processing system is instantiated in a physical computing environment corresponding to the geographic location associated with the electronic transaction request.

9. An apparatus comprising:
a processor; and
non-transitory memory storing instructions that, when executed by the processor, cause the apparatus to:
receive, from a payment gateway device, an indication of an electronic transaction request via a messaging service;
generate, based on the indication of the electronic transaction request, a message comprising a header and body comprising the indication of the electronic transaction request;
broadcast, via a publication/subscriber service, the message to a payment switch platform and an account processing system; and
trigger, based on the broadcasted message, completion of the transaction by the account processing system.

10. The apparatus of claim 9, wherein the publication/subscriber service comprises and event mesh network.

11. The apparatus of claim 9, wherein the instructions further cause the apparatus to:
subscribe to messages posted by each payment gateway device of a plurality of gateway devices to an event mesh network; and
receive, from each payment gateway device as published to an event mesh network, a payment request message to initiate a payment transaction in response to a consumer request.

12. The apparatus of claim 9, wherein the instructions further cause the apparatus to:
wherein broadcasting of the message comprises publishing a topic to an event mesh network.

13. The apparatus of claim 9, wherein the instructions further cause the apparatus to:
analyze the indication of the electronic transaction request, wherein the broadcasting of the message comprises publishing a topic to an event mesh network; and
generate the topic based on characteristics of electronic transaction request.

14. The apparatus of claim 13, wherein the topic is published to a targeted account processing system based on a geographic location associated with the electronic transaction request.

15. The apparatus of claim 13, wherein a targeted account processing system is instantiated in a cloud-based environment.

16. The apparatus of claim 13, wherein a targeted account processing system is instantiated in a physical computing environment corresponding to a geographic location associated with the electronic transaction request.

17. Non-transitory computer readable media storing instructions that, when executed by a processor, cause a computing device to:
receive, from a payment gateway device, an indication of an electronic transaction request via a messaging service;
generate, based on the indication of the electronic transaction request, a message comprising a header and body comprising the indication of the electronic transaction request;
broadcast, via a publication/subscriber service, the message to a payment switch platform and an account processing system; and
trigger, based on the broadcasted message, completion of the transaction by the account processing system.

18. The non-transitory computer readable media of claim 17, wherein the publication/subscriber service comprises and event mesh network.

19. The non-transitory computer readable media of claim 17, wherein the instructions further cause the computing device to:
subscribe to messages posted by each payment gateway device of a plurality of gateway devices to an event mesh network; and
receive, from each payment gateway device as published to an event mesh network, a payment request message to initiate a payment transaction in response to a consumer request.

20. The non-transitory computer readable media of claim 17, wherein the instructions further cause the computing device to:
analyze the indication of the electronic transaction request, wherein the broadcasting of the message comprises publishing a topic to an event mesh network; and
generate the topic based on characteristics of electronic transaction request.
